(19) United States
(12) Patent Application Publication
(10) Pub. No.: US 2018/0320746 A1
(43) Pub. Date: Nov. 8, 2018

(54) METHOD FOR ATTACHING FRICTION LINING ELEMENTS TO A FRICTION LINING SUPPORT

(71) Applicant: Schaeffler Technologies AG & Co. KG, Herzogenaurach (DE)

(72) Inventor: Markus Hesse, Pfinztal (DE)

(73) Assignee: Schaeffler Technologies AG & Co. KG, Herzogenaurach (DE)

(21) Appl. No.: 15/775,559

(22) PCT Filed: Nov. 22, 2016
(86) PCT No.: PCT/DE2016/200530

§ 371 Date: May 11, 2018

(30) Foreign Application Priority Data
Dec. 4, 2015 (DE) 10 2015 224 366.4

(51) Int. Cl. F16D 69/04

(52) U.S. Cl. CPC F16D 69/0408; F16D 2200/0004; F16D 2200/0034; F16D 2250/0092; F16D 2069/0466; F16D 2250/0069; F16D 2069/0491

(57) ABSTRACT

A method for attaching friction lining elements to a friction lining support includes providing a friction lining and a friction lining support, punching a plurality of friction lining elements out of the friction lining, and gluing the plurality of friction lining elements to the friction lining support with an adhesive film. In an example embodiment, punching the plurality of friction lining elements out of the friction lining includes punching out the adhesive film. The method may include supplying the adhesive film to the friction lining support.

### CROSS-REFERENCE TO RELATED APPLICATIONS

This application is the United States National Phase of PCT Appln. No. PCT/DE2016/200530 filed Nov. 22, 2016, which claims priority to German Application No. DE102015224366.4 filed Dec. 4, 2015, the entire disclosures of which are incorporated by reference herein.

### TECHNICAL FIELD

The present disclosure concerns a method for attaching friction lining elements to a friction lining support. The friction lining elements are punched out of a friction lining and glued to the friction lining support by means of an adhesive.

### BACKGROUND

German publication DE 10 2013 218 111 A1 discloses a method for attaching friction lining elements to a friction lining support. The friction lining elements are applied simultaneously on two opposing sides of the friction lining support. The friction lining elements on the opposing sides of the friction lining support are punched out of friction lining semifinished products before or during the attachment of the friction lining elements to the opposing sides of the friction lining support. The friction lining elements on the opposing sides of the friction lining support are pressed and/or heated together with the friction lining support during or after punching. The friction lining support is provided with a base coat of adhesive on both sides, in particular from bottom and from top, before attachment of the friction lining elements. German publication DE 10 2011 086 521 A1 describes a method for production of a friction body, in particular a wet-running friction plate in a motor vehicle. The friction body in operation rotates about a rotational axis. The friction body has a friction region and a connecting region, and wherein the friction body is connected to the friction body support by means of the connecting region. The friction body has a lining support. The lining support has a friction region and a connecting region. The friction region has at least two paper blanks. Each paper blank has a friction region. A first paper blank and the lining support and a second paper blank are pressed to the friction body to a predefined thickness in the friction region by heating and reaction of the binding agent contained in the paper blanks. The binding agent contained in the paper blanks is still in a reactive state before pressing.

### BRIEF SUMMARY

The present disclosure describes a method for attaching friction lining elements to a friction lining support. The friction lining elements are punched out of a friction lining and are glued to the friction lining support by means of an adhesive, in that the friction lining elements are glued to the friction lining support by means of an adhesive film. In production of wet-running friction plates with individual friction elements on a support plate, in conventional methods, the support plates are coated with adhesive by means of roller coating or dipcoating. In order in a further step to fix the punched out friction elements to the carrier plate before the gluing process, a solvent must be sprayed on to dissolve the adhesive, or a further layer of adhesive applied shortly before tacking. Then the friction element must be tacked to the support plate and subjected to the gluing process. By use of the adhesive film, with the method according to the present disclosure, the process step of roller coating/dipcoating may be omitted. With the method according to the present disclosure, the individual friction lining elements may be attached or tacked to the friction lining support by means of the adhesive film directly during the punching process. Then the friction lining support with the friction lining elements tacked thereto may be subjected to a subsequent gluing process. Use of the adhesive film in addition offers the advantage that the adhesive film need be applied only where it is required. Thus for example a toothing region on the friction lining support may easily be cut out by corresponding formation of the adhesive film.

An exemplary embodiment of the method is characterized in that the adhesive film is punched out together with the friction lining elements and supplied to the friction lining support. With the method according to the present disclosure, advantageously individual friction lining elements may be attached to the friction lining support together with the adhesive film in one working step. Thus, particularly advantageously, dissolution or application of a further layer of adhesive may be omitted.

A further exemplary embodiment of the method is characterized in that the adhesive film is applied to the friction lining before the friction lining elements are punched out. The adhesive film advantageously has substantially the same shape as the friction lining, which on supply to the punching process may still have a form with a length and width ratio, i.e. need not necessarily constitute a circular ring disk. The adhesive film has substantially the shape of a circular ring disk or, by deviation, the shape of individual segment parts which are designed advantageously for cost saving. Before the friction lining elements are punched out, the adhesive film is simply glued onto the friction lining. The adhesive film is here advantageously applied on a surface of the friction lining facing the friction lining support.

A further exemplary embodiment of the method is characterized in that the adhesive film is applied to the friction lining support before the friction lining elements are punched out. Here the adhesive film advantageously has substantially the shape of a friction surface to be created by the friction lining elements. The friction lining and the adhesive film have for example substantially the shape of a circular ring disk.

A further exemplary embodiment of the method is characterized in that the adhesive film is a plastic film. The plastic material from which the plastic film is formed is for example polytetrafluoroethylene.

A further exemplary embodiment of the method is characterized in that the adhesive film has a thickness from around ten to one hundred microns. The adhesive film has for example a thickness of thirty microns.

A further exemplary embodiment of the method is characterized in that the friction lining support is made from a sheet metal material. The use of sheet metal material in combination with the adhesive film has proved advantageous.

A further exemplary embodiment of the method is characterized in that the friction lining support has a thickness of around one millimeter. The friction lining support has for example a thickness of 0.8 millimeters.

A further exemplary embodiment of the method is characterized in that the friction lining elements are punched out of a friction lining semifinished product. The friction lining semifinished product is preferably a paper lining.

A further exemplary embodiment of the method is characterized in that the adhesive film has the same shape as the friction lining semifinished product. The adhesive film and the friction lining semifinished product preferably have the shape of circular ring disks. Particularly advantageously, the adhesive film has no toothing, for example no inner toothing as arranged for torque transmission to the friction lining support.

### BRIEF DESCRIPTION OF THE DRAWINGS

Further advantages, features and details of the present disclosure arise from the description below in which various exemplary examples are described in detail with reference to the drawing. In the drawings:

FIG. 1 shows a punch tool with a friction lining support and a friction lining, to illustrate a first exemplary embodiment of the method, and

FIG. 2 shows a similar depiction to FIG. 1, to illustrate a second exemplary embodiment of the method.

### DETAILED DESCRIPTION

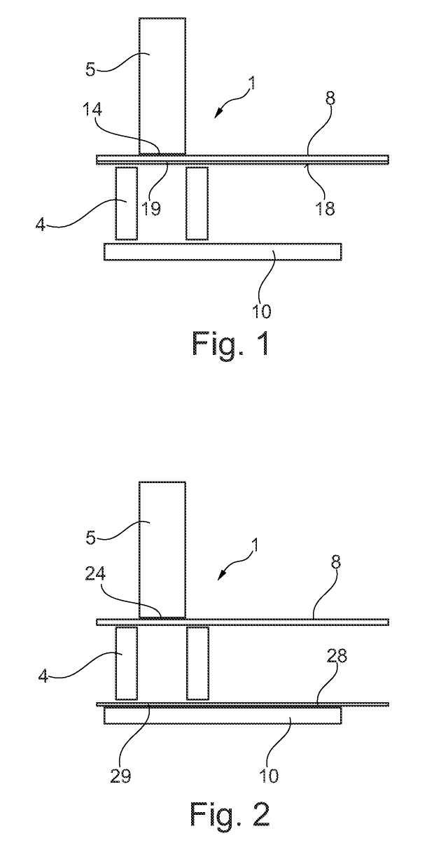

FIGS. 1 and 2 show, in greatly simplified form, a punch tool 1 with a die 4 and a punch 5. A friction lining element 14; 24 is punched out of a friction lining 8 by the punch 5 of the punch tool 1, and attached to a friction lining support 10.

The friction lining 8 may be a paper lining. The paper lining has substantially the form of a circular ring disk. The friction lining support 10 is for example made from a sheet metal material. The friction lining support 10 has substantially the shape of a circular ring disk.

However, the friction lining support 10 includes—on the inside, for example—a toothing, in particular an inner toothing. The toothing, in particular the inner toothing, serves to create a rotationally fixed connection with a rotating part of a clutch.

In the exemplary embodiment shown in FIG. 1, before the punching process, an adhesive film 18 is glued onto the friction lining 8. The adhesive film 18 advantageously has the same shape as the friction lining 8. FIG. 1 shows that the adhesive film 18 is glued onto the underside of the friction lining 8.

During punching with the punch 5, a friction lining 14 together with a film piece 19 is punched out of the friction lining 8 and the adhesive film 18. The punched out friction lining element 4 together with the film piece 19 is then attached, in particular glued, to the friction lining support 10.

Advantageously, the friction lining support 10 is subjected to cleaning before attachment of the friction lining element 14 with the film piece 19. Cleaning takes place for example with a solvent, such as acetone, or laser treatment of the surface.

In the exemplary embodiment of FIG. 2, an adhesive film 28 is glued onto the friction lining support 10 before the punching process. The adhesive film 28 advantageously has the same shape as the friction lining 8. The friction lining 8 and the adhesive film 28 have for example substantially the shape of a circular ring disk. This gives the advantage that the adhesive film 28 is not glued onto the inner toothing on the friction lining support 10.

During punching with the stamp 5 of the punch tool 1, a friction element 24 is punched out of the friction lining 8 and attached to the adhesive film 28, which in turn is attached to the friction lining support 10. A film piece or a region 29 of the adhesive film 28 is compressed by the punch 5 between the friction lining piece 24 and the friction lining support 10.

In the exemplary embodiments shown in FIGS. 1 and 2, the film piece 19; 29 is compressed between the friction lining element 14; 24 and the friction layer support 10 by the punch 5 of the punch tool 1. During compression, heat may be supplied simultaneously in order to initiate or terminate an adhesion process.

By application of the friction lining elements 14; 24 and the film piece 19; 29 to the friction lining support 10 in one working step, the production of friction plates for friction clutches, in particular multiplate clutches, can be significantly simplified.

### LIST OF REFERENCE NUMERALS

1 Punch tool
4 Die
5 Punch
8 Friction lining
10 Friction lining support
14 Friction lining element
18 Adhesive film
19 Film piece
24 Friction lining element
28 Adhesive film
29 Film piece

1.-10. (canceled)

11. A method for attaching friction lining elements to a friction lining support comprising:
providing a friction lining and a friction lining support;
punching a plurality of friction lining elements out of the friction lining; and,
gluing the plurality of friction lining elements to the friction lining support with an adhesive film.

12. The method of claim 11, wherein punching the plurality of friction lining elements out of the friction lining includes punching out the adhesive film, the method further comprising supplying the adhesive film to the friction lining support.

13. The method of claim 11 comprising applying the adhesive film to the friction lining before punching the plurality of friction lining elements out of the friction lining.

14. The method of claim 11 comprising applying the adhesive film to the friction lining support before punching the plurality of friction lining elements out of the friction lining.

15. The method of claim 11, wherein the adhesive film is a plastic film.

16. The method of claim 11, wherein the adhesive film has a thickness from around 10 to 100 microns.

17. The method of claim 11, wherein the friction lining support is made from a sheet metal material.

18. The method of claim 11, wherein the friction lining support has a thickness of around one millimeter.

19. The method of claim 11, the friction lining is a semifinished product.

20. The method of claim 19, wherein a shape of the adhesive film is the same as a shape of the friction lining.
